(19) United States
(12) Patent Application Publication
(10) Pub. No.: US 2016/0004384 A1
(43) Pub. Date: Jan. 7, 2016

(54) Method of universal multi-touch input

(71) Applicant: Hisashi Sato, Kirishima-shi (JP)

(72) Inventor: Hisashi Sato, Kirishima-shi (JP)

(21) Appl. No.: 14/323,136

(22) Filed: Jul. 3, 2014

(51) Int. Cl. G06F 3/041; G06F 3/023

(52) U.S. Cl. CPC G06F 3/0418; G06F 3/023

(57) ABSTRACT

A method of creating a virtual keyboard on a portable electronic device includes providing a multi-touch sensor area, sensing a finger touch on the sensor area, and creating virtual keypads. The keypads' positions are based on the user's finger touch.

### BACKGROUND

Portable electronic devices with key input functions may require miniaturization, versatility, user-friendly features, and convenience. Virtual keys or keypads address some of these requirements and may be0 used to input specific commands or alphanumerical data on a touch screen where a plurality of characters is allocated to a key area. Some virtual keypads appear on a touch screen as set in an area predetermined by a touch or by another input command to display the keypad. One of the challenges users face is that it may be difficult to single-handedly provide input on the virtual keypad, especially when users try to do so during walking, lying down, or holding something in their hands.

Some touch-screens receive input through a user's fingers. Single hand input can be done on such devices when the portable device is small enough to be held and provide sufficient space for free finger movement in the virtual keypad area. With the introduction of larger-screened devices such as tablets and larger screen mobile phones, users now have the option to give up single hand input on those devices and use both hands.

A touch pen may be used to input on a touch-screen keypad as well. In use, such a touch pen is usually held in one hand while the other hand holds the portable device, making single-handed use challenging when using a touch pen.

Even if a portable device is small enough to receive data entry by one or two hands or if a large touch-screen provides a small virtual touch-screen area close to the rim of the screen for data entry, it may still be awkward to deal with the traditional fixed virtual key position or keypad design. This is because users have to check the screen orientation and position, and then adjust their hand position to get their best fit for the virtual keypad area. This awkwardness is often the result of poor keypad design, size, and location as well as the wide variety of hand sizes including those of men and women, children and adults, or all other human size and flexibility variations.

Another challenge when using a touch screen for input is the necessity for adjusting hand and finger position and the requirement that a user watch the screen while inputting data on the keypad in order to ensure the position of the stylus or finger is correct. It may difficult to use a touch pad blindly, even though blind use may permit faster data input.

U.S. Pat. No. 7,941,760 displays one or more soft keyboards on a portable electronic device with a touch screen display, where a user can call up the keyboard, second keyboard, or other input. This reference discusses a user having to check the keyboard orientation and orient their fingers and holding position to get the best fit for the virtual keypad. Users also have to watch the screen during input in order to make sure the position of stylus or finger remains correct.

U.S. Pat. No. 8,174,496 shows activating a touch screen mode by allowing information to be entered on the touch screen in accordance with the received input signal. This patent still does discuss the awkwardness of checking direction, holding and finger position, and adjusting the holding position of a palm and fingers to get a best fit. Users also have to watch the screen during input in order to ensure the position of stylus or finger is correct.

U.S. Pat. No. 8,643,617 shows a method for allocating and arranging keys on a touch screen mobile terminal. By this method, users can choose preferred key arrangements in a sequential order. But users still need to check orientation and adjust the finger and holding position to get the best fit for the virtual keypad. Users also have to watch the screen while inputting data in order to make sure the position of stylus or finger is right.

U.S. Pat. No. 4,977,397 shows a touch-control mouse on which a user can draw using their finger on a touch-control film assembly, which results in a variable potential value for x, y coordinates and computer-calculated relative direction, speed, and amount of displacement on x, y coordinates. The data is sent through a standard RS-232 connector to a PC to control the positioning of the cursor on the computer display screen. The touch-control mouse pad provides limited information and x, y coordinates, direction and speed. The x, y coordinates and computer-calculated relative direction, however, are not discussed and none of further input information is suggested such as calculated information from a multi-key-pad combination. There is no indication about mobile mouse device or a manner of holding such device, because the touch-control mouse is set on a desk or table in the embodiments.

U.S. Pat. No. 6,278,443 shows an on-screen mouse to which user input may be applied by rolling of the touch finger to move the pointer or scroll on the screen. Touching of the screen activates the device to enable the detection of any rolling of a fingertip in an orthogonal direction. The x, y coordinates and computer-calculated-relative direction move a cursor or pointer or, during scrolling, the whole screen of data may be moved. Clicking is done by clicking on center of the on-screen mouse. But no further input information besides x, y coordinates, speed, direction, and clicking is suggested. The screen has the finger-activated mouse area located at a fixed position on the screen so that the position may block the user's view of the screen. Furthermore, users may feel awkward about the fixed position of a clicking button located in the middle of on-screen mouse depending on user's hand size.

U.S. Pat. No. 7,119,795 shows a touch sensitive pad having assigned mouse buttons on the keyboard. The user can use the touch sensitive pad without separating their hands from the home positions. But again, further input information is suggested such as calculating information from a multi-key-pad combination. Furthermore, users may feel awkward about the fixed position of clicking a button located in the middle of an on-screen mouse depending on a user's hand size.

U.S. Pat. No. 8,462,132 show a method and a device for inertial movement of a window object. Multiple touch points obtain the quantity of displacement and the quantity of rotation based on two such touch points. No further input information is suggested such as calculating information from multi-key-pad combination. As applied to a portable device, users may have to hold the multi-screen device by one hand and operate window object such as stylus or finger by another hand. The device does not have a click button in the window, and users have to occasionally reset their click button manually. Users may feel awkward about the fixed position of clicking button depending on user's size of hands and fingers.

### SUMMARY OF THE EMBODIMENTS

The embodiments relate to a method of inputting commands or data into portable electronic devices, such as handheld input sticks, mobile phones, portable computers or game devices.

A method of creating a virtual keyboard on a portable electronic device includes providing a multi-touch sensor area, sensing a finger touch on the sensor area, and creating virtual keypads. The keypads' positions are based on the user's finger touch.

### BRIEF DESCRIPTION OF THE DRAWINGS

FIG. 1a shows a virtual keypad on a terminal.

FIG. 1b shows the terminal of FIG. 1a held by a user.

FIG. 1c shows the terminal according to another embodiment.

FIG. 2 is a block diagram depicting a portable electronic device according to an embodiment.

FIG. 3 is an example of a dialog screen according to an embodiment.

FIG. 4 is a logic flow diagram depicting a method of setting keypad position according to an embodiment.

FIG. 5 is a flow diagram depicting a method of inputting commands according to an embodiment.

FIG. 6 shows touch-sensor pads at the top and side surface of a pen type entry device according to an embodiment.

FIG. 7a shows a virtual keypad displayed on a pen-type entry device with a collapsible holder.

FIG. 7b shows a virtual keypad displayed on a pen-type entry device as shown in FIG. 7a with a collapsible holder according to an embodiment.

FIG. 7c is an overview illustrating a user holding the pen type entry device depicted FIG. 7a.

FIG. 8a shows a subsidiary virtual keypad displayed with dotted lines provided with subsidiary virtual keypads next to main virtual keypads shown in FIG. 1c on a touch screen of the terminal.

FIG. 8b shows a user holding the terminal of FIG. 8a.

FIGS. 8c-8e show virtual keypads in use on a touch screen in use as a mouse pad.

FIG. 8f shows a user's hand using the screen as mouse pad as described in FIGS. 8c-8f.

FIG. 8h shows a user holding a screen terminal to use as a mouse pad.

FIG. 8i shows a virtual keypad displayed with dotted lines in the area of dotted line on the touch screen of FIG. 8h.

FIG. 8j shows a user holding a screen terminal in use as a mouse pad and input command.

FIG. 9 is a flow diagram depicting a method of setting keypad position to be used as a mouse pad.

FIG. 10a shows a touch sensor pad displaying electrical “ON” touch pad sensors under a finger as well as displaying a created virtual key area.

FIGS. 10b and 10c show two virtual keys, the original key and the modified key that has been shifted by a finger touch.

### DETAILED DESCRIPTION OF THE EMBODIMENTS

### Introduction

The method and system described herein work with at least portable electronic input devices that receive specific commands or alphanumerical data using touch sensor input. The system and method provide easily accessible, quick start, and easier data entry on the devices according to a user's finger position.

Specifically, the system and method may generate custom-located and sized virtual keypads or keypad areas in touch screens in accordance with a user's desired finger position. This position need not be preset.

The system may also generate customized virtual keypads on virtual keypad sticks, or virtual controller bars, in accordance with natural finger position of a user.

The system further may provide blind touch input without confirming finger positions from just holding a device to performing inputting, as well as starting keypad entry on virtual keypads so that users do not need to check finger positions when beginning to input commands or data followed by continuous key entry.

The system further allows a user to carry out single-handed data entry.

Summary

The system described herein may include the following, which will be described in greater detail below: a touch key area and a group of touch sensors, such as touch sensor screens or touch sensor pads, equipped on the surface of input devices.

In use, when users hold the input device by hand, their fingers touch the touch sensor area and the system may generate a virtual keypad underneath each finger. The virtual keypads are not located at a fixed position, but their location is customized, where the position of the virtual keypads may be set by the natural finger position on the touch key area at the initial stage of data input, and/or a predetermined position to fit most keypad positions. Thus, the system creates a custom input method for the user.

The system shown herein is an exemplary key input system for portable electronic devices. It is not limited in use to a particular type of communication system or configuration of system elements.

Description

The exemplary systems and methods will also be described in relation to command entry or alphanumeric entry, modules, and associated hardware. In order to add clarity, this description omits well-known structures, components, and devices that may be shown in block diagram form. For purposes of explanation, numerous details are set forth in order to provide a thorough understanding of the method and system. It should be appreciated, however, that the system may be practiced in a variety of ways beyond the specific details set forth herein.

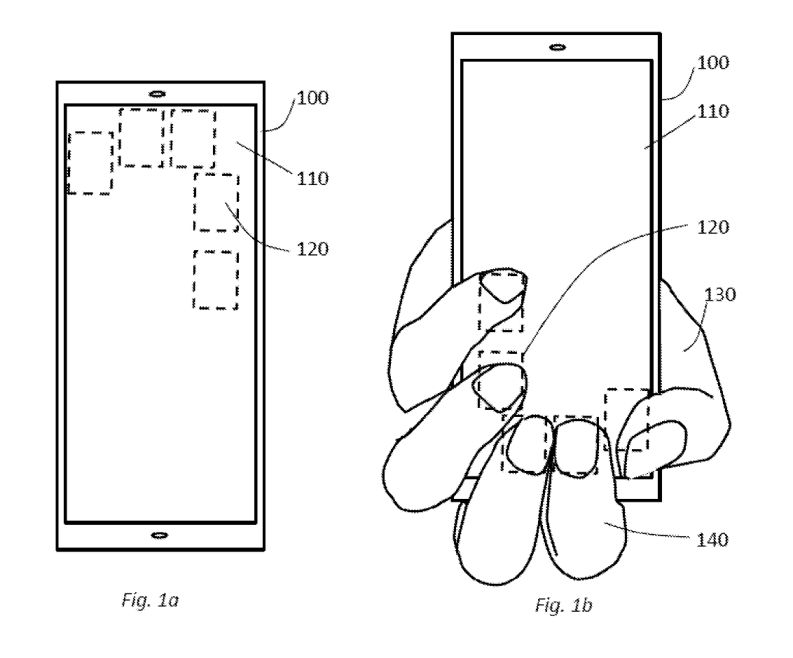

FIG. 1a shows virtual keypads 120 displayed on a touch screen 110 of a portable electronic device 100, such as a tablet. The five dashed squares show positions of the virtual keypads 120 created from the device 100's initialization at the beginning of use.

With reference to FIG. 1b, a portable electronic device 100 may be held by a hand 130 contacting all fingers 140 to the multi-touch screen 110. During an initialization, every finger 140 may touch the multi touch sensor screen 110 for a certain time that is preset beforehand as default or customized. Following this contact period, keypad 120 sizes and positions may be optimized by a keypad setting program to create the keypads 120 on the touch screen 110. The keypad 120 sizes, positions, and pitches may be variable by user. Thus, once the virtual keypad 120's setup is completed, its configuration may be saved unless it expires due to the settings not being saved or the initialization going to sleep for lack of user response.

What this system provides is a position of keypads 120 that is customized for each finger 140 during natural holding of the device 100, regardless of the size of an individual finger or holding style. It should be noted that as shown, there are five virtual keypads 120, however, any other quantity of keypads 120 may be provided.

It may not be necessary to check finger allocations to start use, that is, set-up and initialization may not be necessary. During the device and pad initialization, the finger/hand position and size may be preset using average or final position (last position used on the device) data within a customizable specified time frame.

In one embodiment, no setup at all may be necessary on first use: A predetermined default keypad 120 position that averages many hand sizes may be stored in the device 100.

FIG. 1c shows a user holding the device 100 having a different set-up for the virtual keypads 120 than was shown in FIG. 1b. In this setup, the user's fingers 140 are oriented in different positions. Some users may feel comfortable holding their fingers 140 during inputting on touch screen 110 with this holding style rather than the style in FIG. 1b, in which the index finger and middle finger are on the same side of the portable device 100. A holding style depends not only personal preference but also a device's size, shape, or weight.

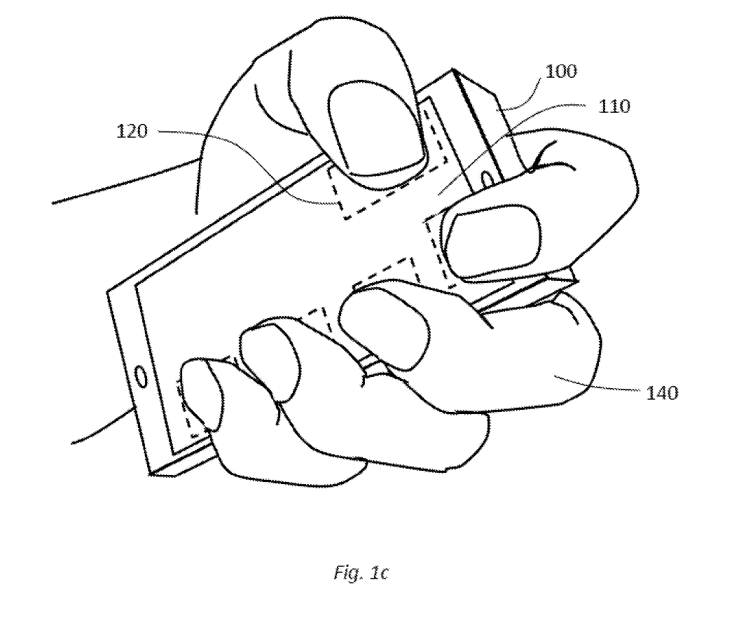

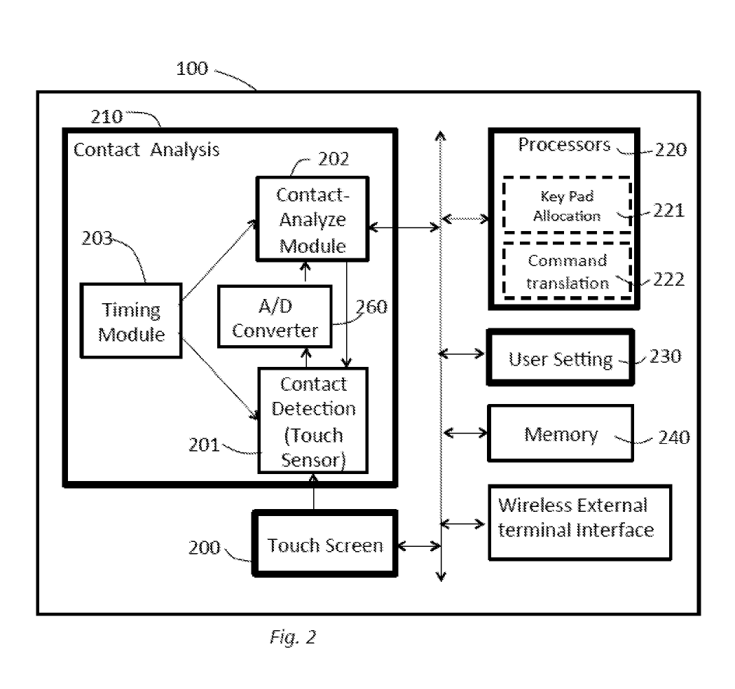

FIG. 2 shows a block diagram depicting a portable electronic device according to another embodiment. The touch-sensor-equipped portable electronic device 100 comprises at least a touch screen 200, contact analysis application 210, processors 220, user setting application 230, and memory 240.

The contact analysis application 210 may have a position-detective touch sensor 201 that detects contact for a touch pad, a touch screen, or any other panels that are capable of touch/multi touch interaction. For a multi-touch screen that is an electronic visual display, capacitive sensing technology based on capacitive coupling that takes human body capacitance during inputting may be used. In use, a resistive touch screen may include several layers including two thin transparent electrically-resistive layers separated by a thin space. Or the screen may use a surface acoustic wave panel that uses ultrasonic waves that pass over the touch screen panel, are absorbed by finger touch to the panel, and thus change the wave on the touch event. Capacitive sensing technology may provide more accuracy in position detection. Resistive technology in multi-touch pad or multi-touch screen may be preferable for a thin panel, flexible panel or low cost applications.

The contact analysis module 202, processors 220, and user setting module 230 may work together to conduct keypad allocation and command translation. These programs may be installed in the processors with default conditions and a user may set program parameters through the user setting application 230. The contact analysis unit 210 collects contact information under instruction from the processor 220 and sends data to processors 220 to find optimized suitable pad size and allocations for a user. Those data may be also sent to the memory 240.

At the beginning of use or during an initialization, new keypads 120 may be assigned in the touch panel area 110. A keypad allocation program 221 for user settings may allow users to set preferred parameters like number of pads, data collection time for initial pad allocation, preferable pad shape, displaying or non-displaying virtual pad, and the pad color.

For command translation 222, the processor 220 may translate data obtained from finger contact analysis into commands or characters in accordance with a registered reference data stored in the memory.

The device 100's settings may be set or stored over a wireless or wired external interface 250.

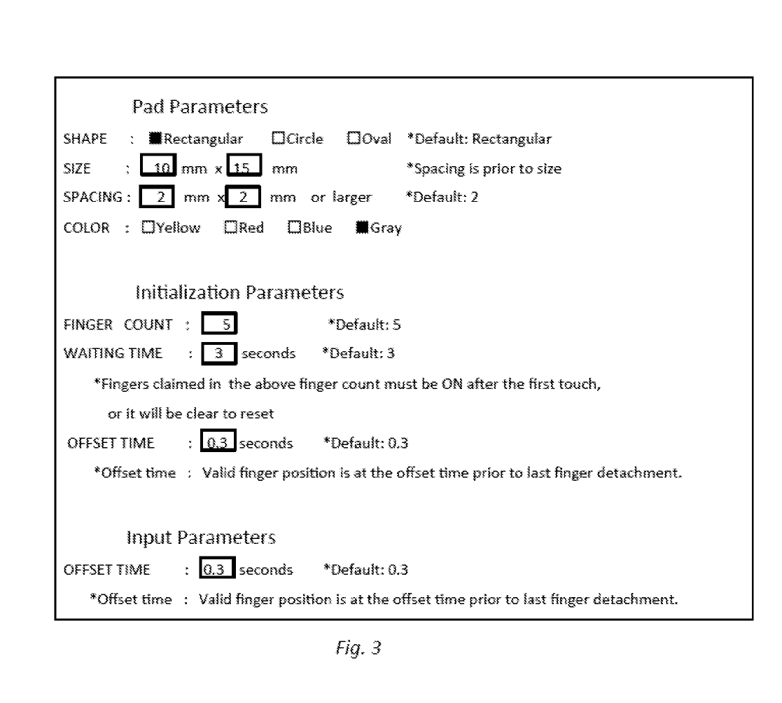

FIG. 3 is an example of a user setting dialog screen 300 according to an embodiment. This dialog screen 300 for customizing a user's experience may appear in the multi-sensor display equipped on portable electronic devices, external connecting devices, or host devices that deliver input parameters wirelessly or through removable memory cards.

Although many parameters exist, FIG. 3 only shows a few in its example window 300. Pad parameters 310 specify shape, size, spacing, and color of virtual pads that sense finger touch once it is set in the multi-sensor area. The default number of keypads in the settings area may help users who want to set a custom size, for example, 2 mm as shown. A program may use this input information to calculate optimum position and pad size in accordance with natural finger position.

Initialization parameters 320 may specify a finger count, a waiting time, and an invalid period. All fingers must be on the touch screen 110 after the first touch, which starts initialization, during the waiting time; otherwise, the waiting will be cleared and reset to wait for another first finger touch. An offset time may be set to get valid finger positions because it may take some time, even very short, between the user's start of all finger detachment and the user's removal of their last finger detachment after user's decision of input the active finger positions. For example, if the offset time is set to 0.3 seconds, contact analysis 210 may determine finger positions from the cache memory of 0.3 seconds before the time of detaching all fingers, provided the finger count matches to the finger count parameter set and described in FIG. 3. Information for a new keypad location may be acquired under these conditions as well.

Input parameters 330 may specify an invalid period that is between the valid finger position time and the time of last finger detachment. For example, if the invalid time is set to 0.3 seconds, contact analysis 210 may determine finger positions from the cache memory of 0.3 seconds before the time of detaching all fingers. Smooth input may be achieved according to a user's preferences.

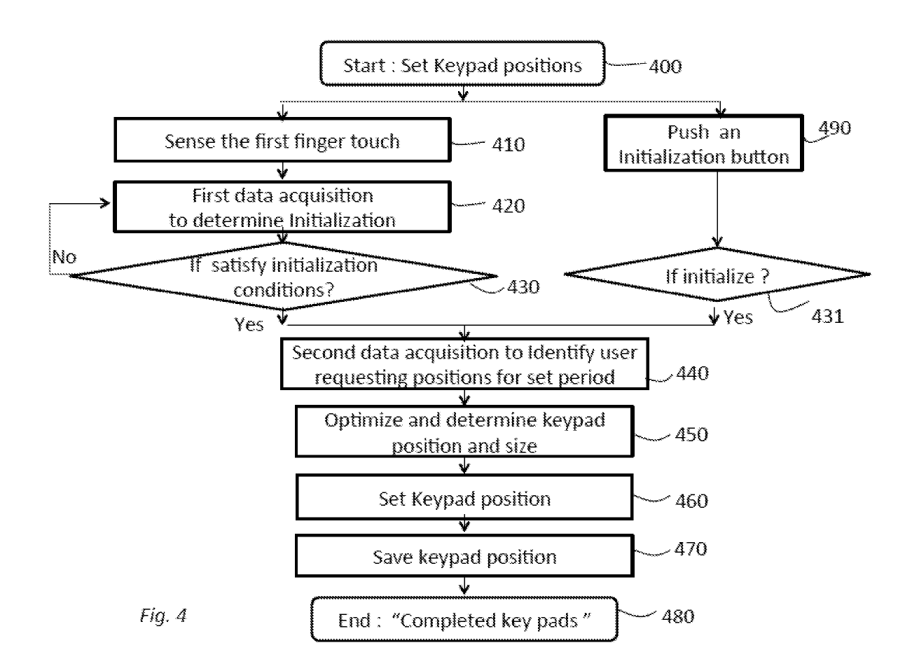

FIG. 4 shows a logic flowchart for setting virtual keypad positions 400 performed at the initialization of using a portable electronic device. First, the system may have to get an initialization command. FIG. 4 shows two kinds of methods for receiving an initialization command: (1) Pushing an initialization button 490 on the device and obtaining initialization command 431; and (2) Receiving the command through the touch sensor pad, and this path begins at the step of sensing the first finger touch 410.

Once the first finger touch 410 is sensed, first data acquisition 420 may require a user to touch all fingers on the sensor pad area for a certain period of time. If there is no finger touch made or detected during the preset time (first data acquisition 420 for example), the first data acquisition may be reset.

The number of fingers is usually given as five as default but may be changed according to a user's preference The finger position of the five fingers may be within the reasonable area and reasonably separated because fingers too close together may be hard to distinguish. The conditions of finger configuration may be preset in order to avoid any input mistake. If the finger contact information does satisfy the preset condition, the first data acquisition will continue until the contact count and position satisfy preset conditions 430. When it is verified that all fingers contact the screen 110 for a certain time and that all other conditions are met, the initialization command 430 may be confirmed.

When the initialization command is confirmed 430, the second data acquisition 440 may start for a preset data acquisition time that may be changed from default numbers of three seconds, for example, by a user's input.

Custom final finger positions may be preferred to be used during input. And a user's fingers can be adjusted to a comfortable position during the second data acquisition period. A user may provide an offset time for final finger contact, because every finger may not be released at once when a user means to release of all their fingers. In order to avoid accidental data input during finger release, finger position data may be stored and updated in memory for the period of offset time, and the data in memory may be called for final finger position, when all fingers are “OFF” from any finger “ON.” The offset time for final finger contact time may be set to a short time and grow even shorter with proficiency.

After data acquisition, the virtual keypad positions and sizes 450 may be optimized and determined, and eventually the keypad size and position may be fixed 460 and saved 470.

In order to get ideal and customized keypad positions and sizes, a simulation program for best fitting may be provided, with user settings 230, such as number of pads, pad size, spacing between pads, and maximum length of finer moving area. The simulation program may assist in best fitting keypad sizes and allocation based on observed finger usage. For example, a user may tilt their ring finger a certain way or space their pinky further from their ring finger than other fingers, The simulation program could monitor this real usage and adjust the settings automatically in response to use.

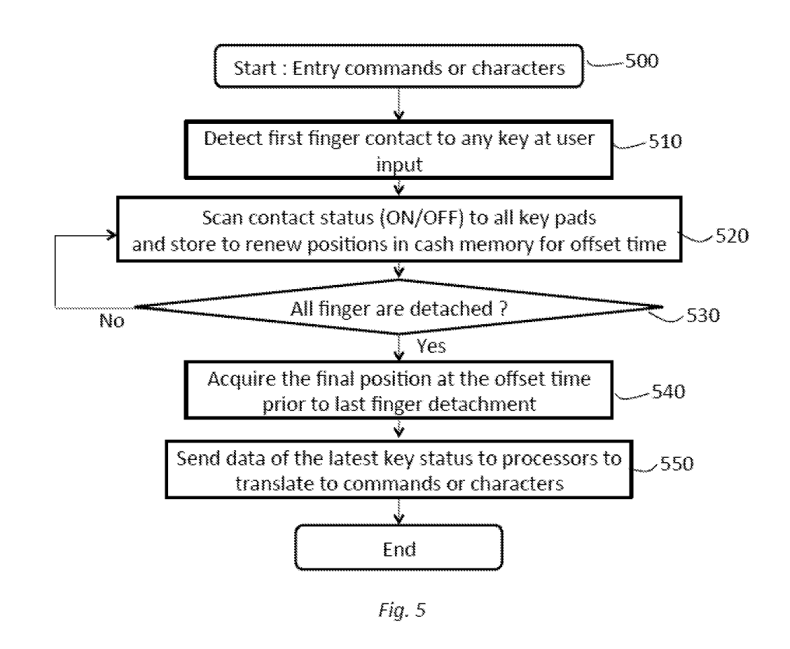

FIG. 5 shows a method for inputting commands (any commands, but for example, the types of commands available from a menu bar) and characters (alphanumeric or other characters) in a multi-touch panel of portable electronic device. The method may be initiated when a first finger contact 510 to any virtual keypad is detected. Then, a contact status on each virtual keypad is scanned and gives ON and OFF status of the keypad using a timing clock 203. The latest contact information 520 is saved for the offset time period that is preset as default or set using user setting 230, until it detects that all fingers are detached 530. The finger position may be obtained from the data at an offset time before the last finger detaches, and the position may be stored in a cache memory 540. The final step is that the most current information regarding the latest key status is sent for data conversion 550 in order to be translated into a command or character.

Input of a signal for a command or character may be completed and determined within the certain preset time just before all fingers are released. If there is no finger touch made or detected during the preset time, the first data acquisition may be reset. The virtual keypad 120 is normally in an electrically-off state and becomes electrically-on when a user touches their finger to the touchscreen, and again electrically-off when the finger is released.

The electrically-on status generated by fingers allows commands or alphanumerical data entry where programmed computing may be carried out. Theoretically thirty one types of commands or alphanumerical characters may be given by first stage input with five fingers, and nine hundred and sixty one by the combination of the first stage and second stage input.

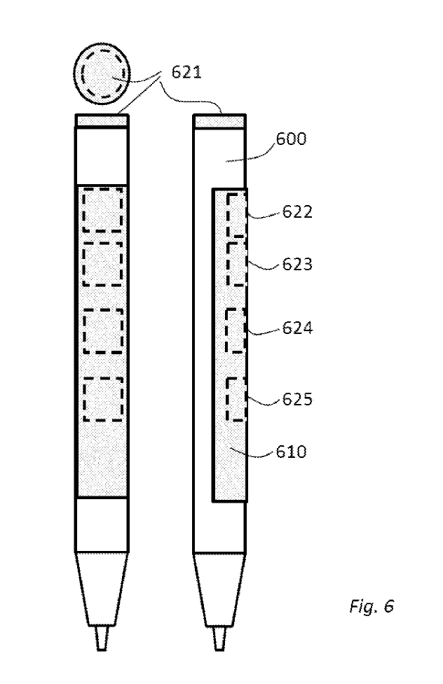

FIG. 6 shows a portable device 600 with virtual keypads displayed on a pen type entry pad 610 according to another embodiment. There may be two separated sensor pads 621, 625 at the top and side of the portable input device 600. The virtual keypads 621, 622, 523, 624, and 625 are shown by dotted lines on the multi-touch sensor pad 610 and their position, size, etc. may be set according to the procedure described herein and shown in FIGS. 3 and 4. In use, a user's thumb may contact the top end of the body and the other fingers contact the pen device 600's cylindrical surface. The multi-touch sensor pad 610 may not need to be an electro-visual touch screen, but may use resistive technology in multi-touch pad that normally includes a pair of thin layers with a flexible structure because the resistive touch pad is thin enough to roll on the pen type body 600 and not interfere with its use as a pen.

The shape and location of the input pad 610 (rectangular as shown) can be modified. The multi-touch pad 610 may be applied to the pen-type device 600 herein but could also be applied to different shaped devices such as a touch sensor stick or bar.

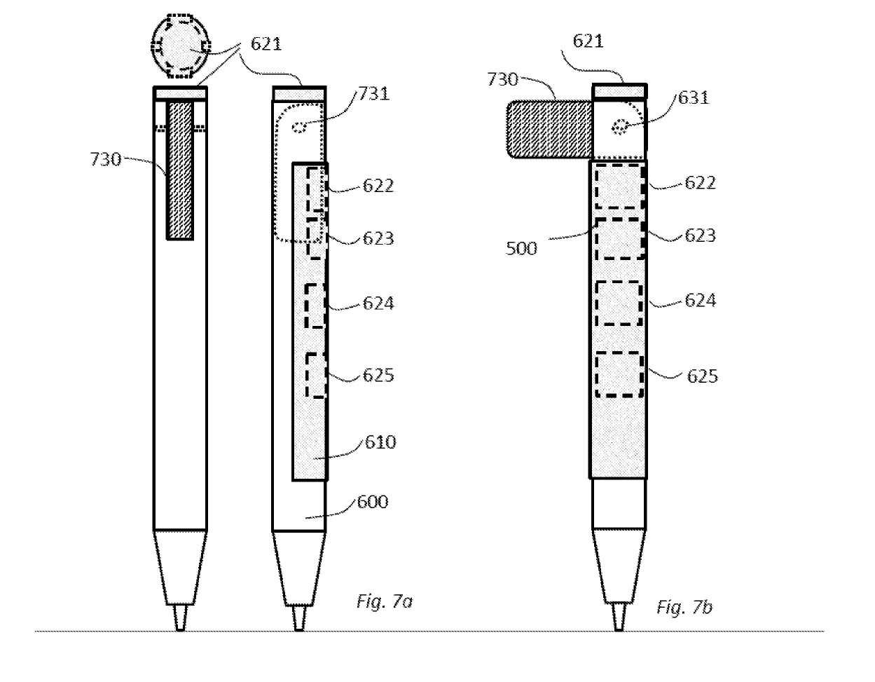

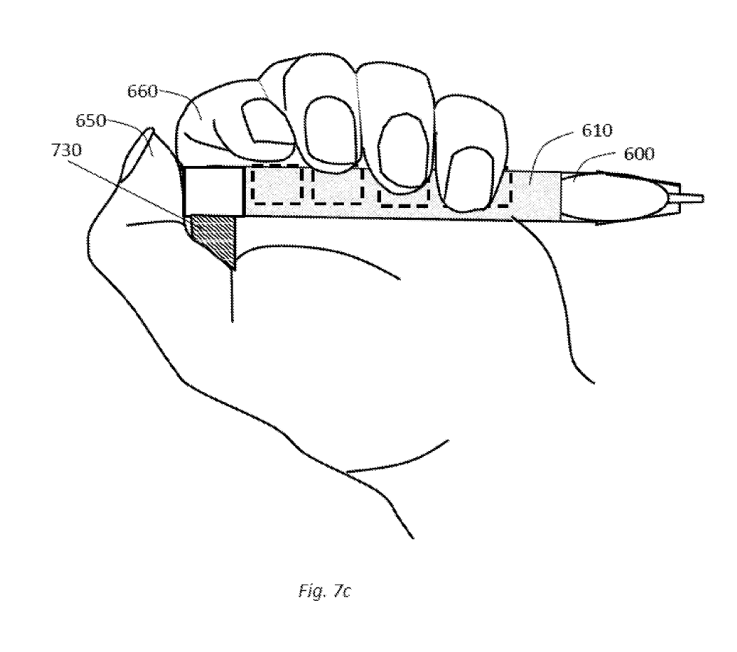

FIG. 7a shows a virtual keypad displayed on a pen type entry device 600 with a collapsible holder 730. The collapsible holder 730, which can be folded and stored in the body of the multi-touch input device 600 described in FIG. 7b by its rotation about hinge 731, is used to hold the body rigidly during inputting data or commands. FIG. 7c shows the device in use. The collapsible holder 730 may be held between a user's thumb 650 and index finger 660, and this arrangement may minimize the movement of the device 600 during finger input. The initial keypad 610 positioning may be done by attaching the collapsible holder 730 between the two fingers.

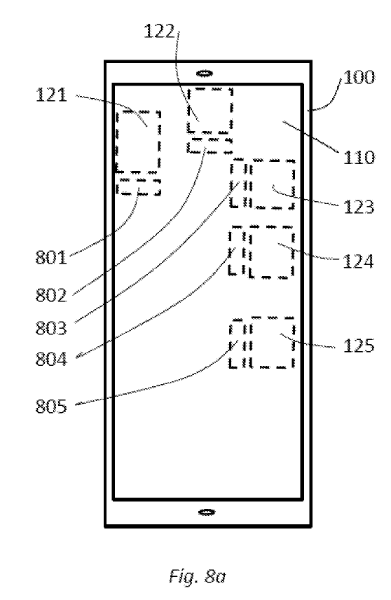

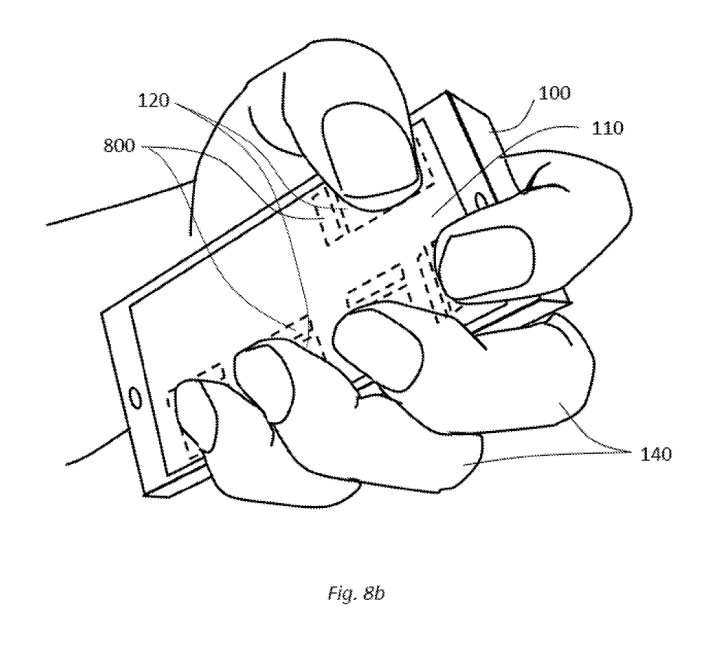

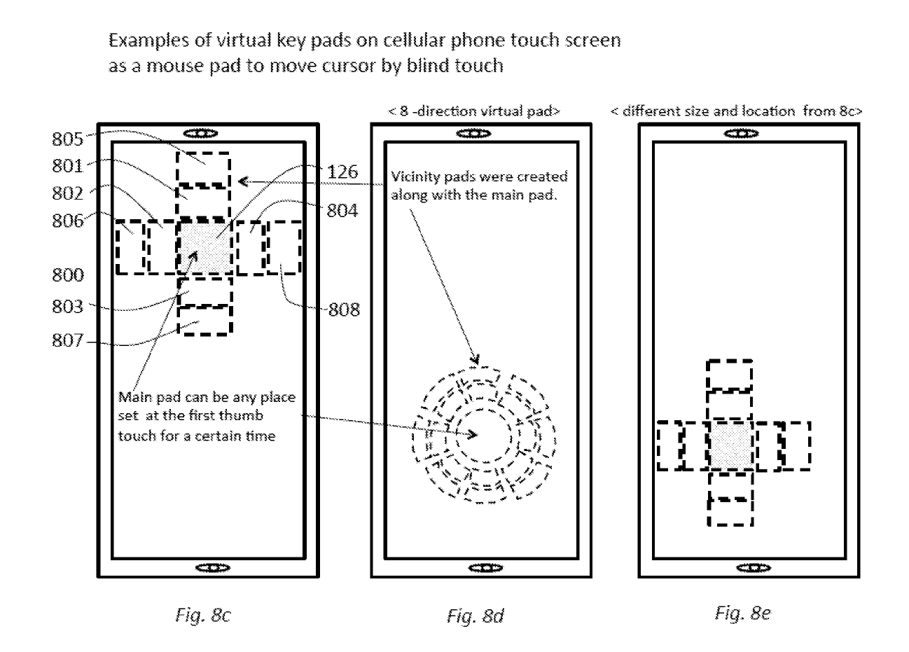

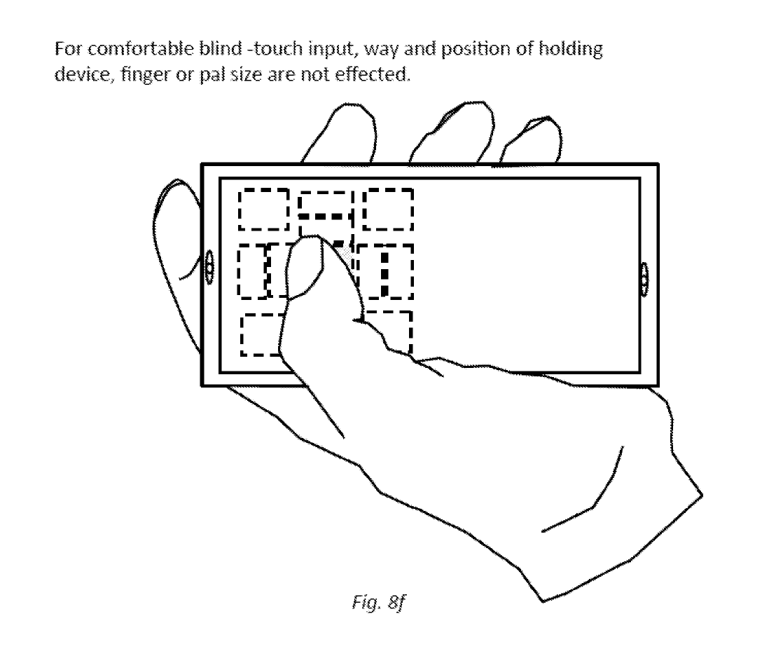

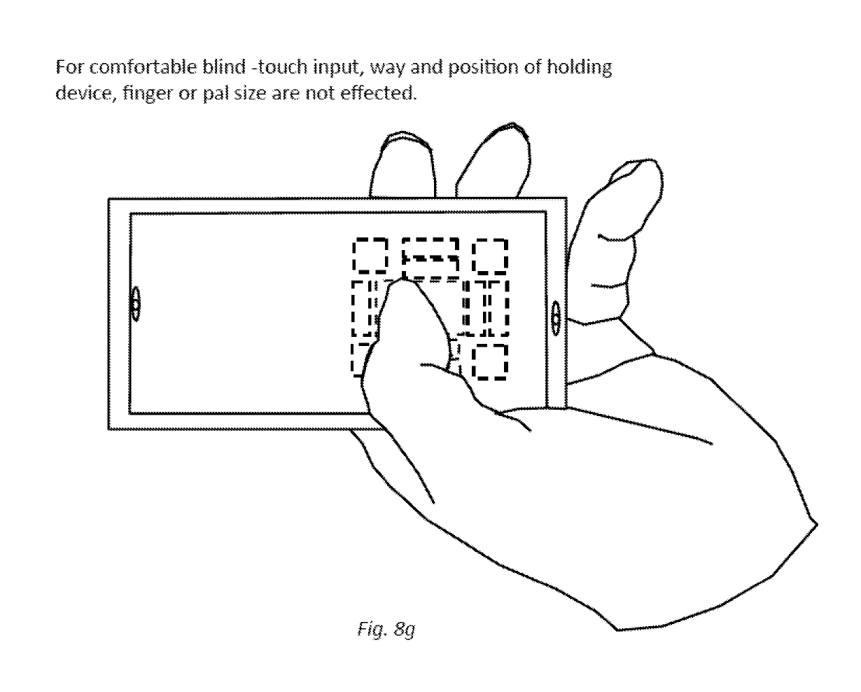

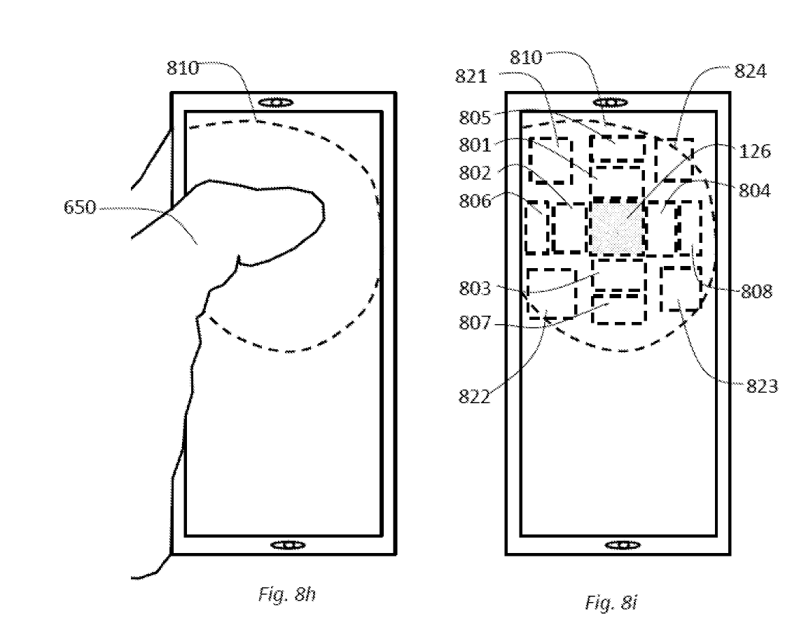

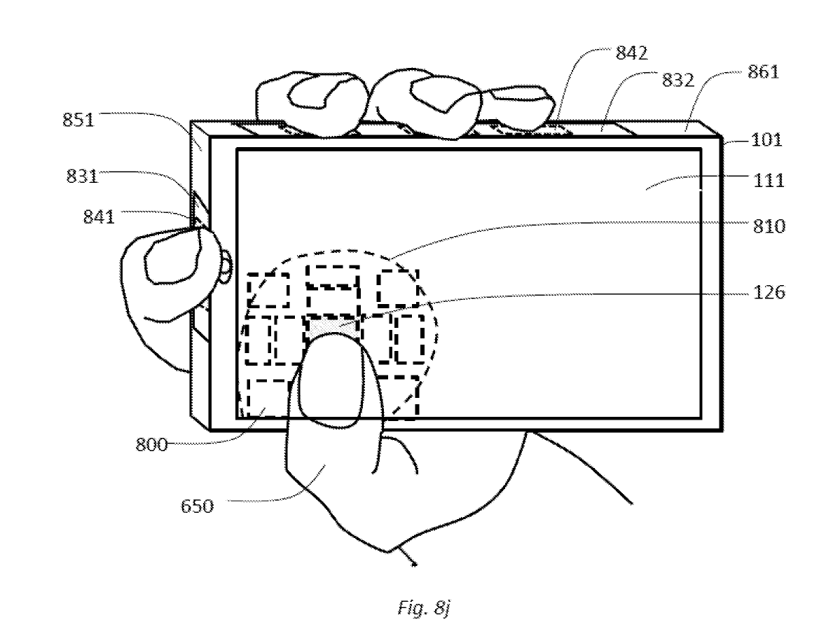

FIG. 8a shows subsidiary virtual keypads 801, 802, 803, 804, and 805 next to the previously discussed main virtual keypads 121, 122, 123, 124, and 125 respectively. The main keypads 121, 122, 123, 124, and 125 are the same as shown in FIG. 1c on a touch screen of the device 100 when those positions and sizes are fixed by the keypad setting program. The subsidiary virtual keypads may be created at the same time as the main keypads are created and set according to the keypad allocation program installed in the processor 220. Users can set specific preferred parameters of the subsidiary virtual keypads, such as necessity, direction from a main keypad, size, and appearance. Subsidiary keypads can be located anywhere around main keypads to enhance input versatility. An example of subsidiary virtual keypad usage would be to use command or character information by continuous finger touch from a main keypad to the related subsidiary keypad.

Another example of an embodiment using the subsidiary virtual keypads is the use of a pad device as a mouse pad with blind touch for interaction with, perhaps, an external computer or display. Such a virtual mouse may be provided with three main virtual keypads, with two subsidiary virtual keypads for each main keypad respectively. A pair of subsidiary virtual keypads may be located near-palm and far-palm as positioned from the main virtual keypad when the device is held in a hand.

A side movement of each finger from a main keypad to a subsidiary keypad may command up and down by one finger, right and left by the other finger, and the rest finger may be used as an enter key. The rest of fingers may be used for page up and down, or as right click button of the conventional mouse, too. In this example, after a certain time of using necessary fingers, a user can start a mouse-like operation, even in a pocket or out of the user's sightline.

FIG. 8b shows the terminal of FIG. 8a wherein fingers 140 are custom fit to the virtual keypad set at the beginning of use. In such use, a user may slide a finger 140 from a main virtual keypad 120 to a related virtual keypad 820 to input another command.

FIGS. 8c-8i show example keypad configurations using the keypad setup as a mouse or similar proximity movement sensor. During setup of the mouse configuration, the main key 126 acts as the center of the mouse, and the pads 801, 802, 803, 804, 805, 806, 807, and 808 may correspond to directions of the controlled mouse to accelerate mouse movement as a finger moves away from the main key 126. FIG. 8h shows the keypads around the key pad 126 in a circular configuration. It should be appreciated from this configuration and that as shown in FIG. 8f, that a user could use the device 100 without seeing it, sliding their finger across the screen blindly and moving a corresponding pointer on a visible display.

FIG. 8h shows a user holding a screen terminal to use as a mouse pad in order to communicate with the device about finger length range or span, which is shown with dotted line. It should be appreciated that a user's reach when using a device is limited by their finger size, hand size, and flexibility. The user's thumb may be, for example, used as an input finger on mouse pad as shown in FIGS. 8a-8i. When a user wants to set a virtual keypad for mouse operation at the beginning of use or reset the former pad position, the user may move the thumb in all directions keeping the thumb on screen to communicate its range to the device 100. The touch sensor screen detects the thumb's movement as shown by the dotted line 810 for further computer calculation to determine an appropriately-sized and operative virtual keypad as a mouse pad. This finger range measurement could be done using other fingers as well but as shown and held, it makes most sense in this example that it controls the mouse-like movement.

FIG. 8i shows a virtual keypad shown as dotted lines on the touch screen 110 of FIG. 8h as set by computer calculation based on the thumb range measured in FIG. 8h. A manipulative virtual keypad configuration may be automatically created by computer calculation within the dotted area 810 in order to assist a user to move a cursor and scroll using a blind touch.

In this embodiment, there are many subsidiary virtual keys around the main key 126 that may function as a click button when the thumb touches and releases it independently. Keypads 801, 802, 803, and 804 may correspond to up and down and left and right pad. When the thumb (or other finger) touches the key 801 independently or continuously from the main key 126, the cursor may go up, go left for key 802, down for keypad 803, and right for keypad 804. Keypads 805, 806, 807, and 808 may move faster or accelerate up, down, left, and right. The thumb may touch the keys 805, 806, 807, and 808 independently or continuously as it moves from the main keypad 126 through the intermediate keys 801, 802, 803, and 804. Keypads 821 and 822 may be up and down scroll keys respectively, and keys 823 and 824 may be right and left scroll key respectively. Another type of main key such as a key for a user's index finger or vicinity key such as faster scroll keys or secondary click key may be available as well.

Continuous drawing using finger movement from one key to another key can be defined by a time difference between a release from one key to an ON time for another key, which must be within a specified time. It is also possible to take a status of both ON, making the designated keypad position closer. Touch information may be neglected, if a thumb touches more than one key except for a designated keypads combination.

FIG. 8j shows a user holding a screen terminal to use as a mouse pad and input command. A virtual mouse pad system comprises a main keypad or click key 126 and a subsidiary keypad 800 that is created, using a mouse set-up program, within the finger span range of thumb 810 on a multi sensor screen 111 equipped on the portable screen device 101. In addition to the virtual mouse pad system, a virtual keypad 841 on a sensor pad 831 may be created on the device's side surface 851, and virtual keypads 842 on the sensor pad 832 may be created on the device 101's other side surface 861. In this example of embodiment, a user may move the mouse by the thumb and input command or characters using their other fingers.

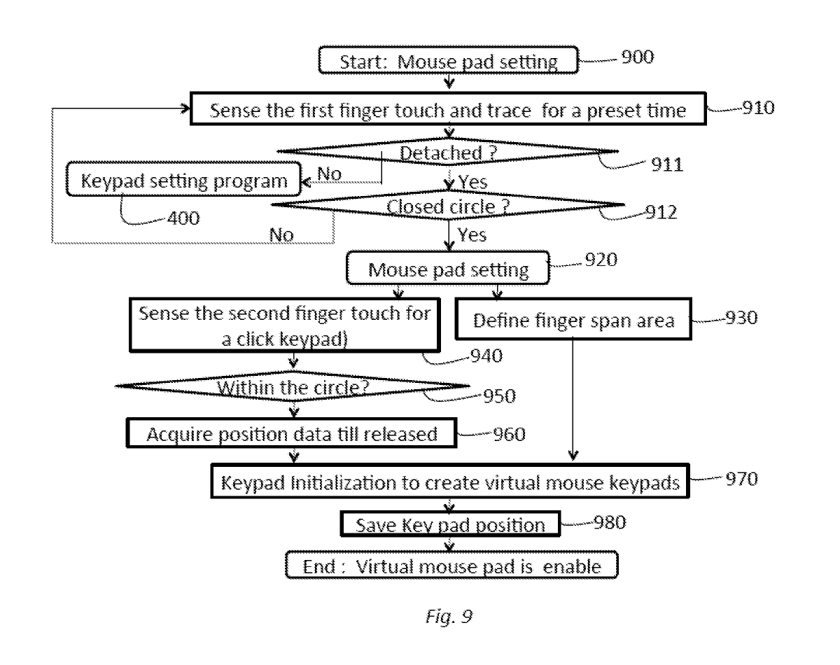

FIG. 9 is a flow diagram depicting a method of setting a keypad position to be used as a mouse pad 900. A program providing mouse pad use may be activated according to the determination of a finger contact on a touch sensitive pad 910. In the example of embodiment depicted in FIG. 8h, drawing a closed circle at a thumb's length may be required during set-up, so that the finger touch may be traced for a preset time specified by a user or by a default value.

If the finger is detached after drawing a closed circle 912, the program goes nest step of mouse pad set up 920, unless the finger is continuously “ON,” resulting in initiating the keypad set up program 400, or if the traced line is not a closed circle resulting in starting from the beginning. In the mouse pad set up 920, two kinds of data may be processed. One is an finger span area 930 defined as finger reach span from the circle line drawn by the first finger touch 910. The other is the position of the main keypad, that is, a click key for a mouse, which is obtained by the second finger touch 940 that should be within the circle obtained from the first finger trace 950. The main keypad position is acquired when the second touch finger released. Virtual mouse keypads may be created from the combination of the finger span area 930 and the main key position 960 under keypad initialization 970 in which the main keypad and surrounding subsidiary keypads are arranged with fitting preset optimization conditions. The final keypad positions may be saved for further operation 980.

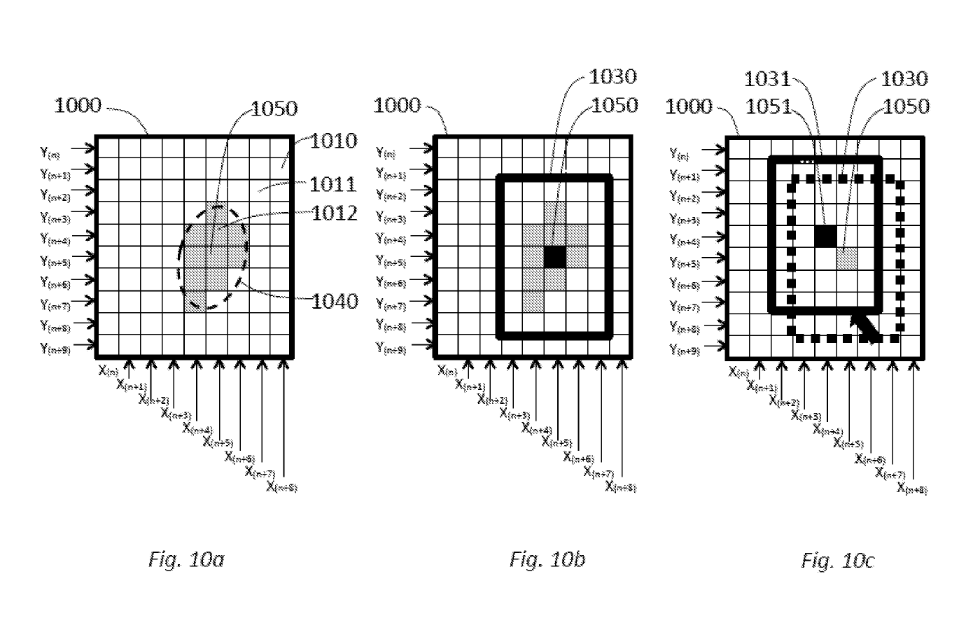

FIG. 10a shows a touch sensor pad 1000 displaying electrical “ON” touch pad sensors 1011 under a finger 1040. The touch sensor pad 1000 comprises touch pad sensors 1010 that are located within a cross section of orthogonally arranged X circuit lines and Y circuit lines in the touch sensor pad or touch screen 1000, connected to scanning receiver (not shown) respectively. The touch pad sensors 1010 may have two kinds of electrical statuses, 1011 and 1012. White color pad sensors 1011 mean electrically “OFF” and dark color pad sensors 1012 mean electrically “ON.” When a detected output voltage is larger than a threshold value, the touch pad 1000 concludes that the user's finger or stylus (outlined as 1040) is in contact with the touch pad 1000, and gives an “ON” status for the subject pad sensors 1012

FIG. 10b shows a virtual key 1030 created at the optimum position with suitable size by a virtual key creation program in accordance with the information of “ON” pad sensors and as described herein. In this example, the virtual key 1030 has a size that was pre-input in pad parameters setting described in FIG. 3, and the center of virtual key is located at the blackened pad sensor 1051 coordinated at (X(n+5), Y(n+5)), which are the middle of dark color pad sensors in X and Y coordinates respectively. Among various methods of optimization of virtual key position setting, this center matching method is represents just one point information that may induce a virtual key with preset key size information under an optimization program.

FIG. 10c shows an example of moving the virtual key position from an area 1030 to an area 1031 following a shifting center position of dark colored sensors from 1050 to 1051. The touch positions of user's finger may move around the original virtual key 1030 during actual input. A user may not keep their finger on the original key, but move around the original virtual key or diverge from it over time. The location and size of a virtual key may be modified during input operation from the original virtual key or previously modified virtual key, with reference of stored information of latest finger positions.

One of the embodiments may move or modify the virtual key position or size during input operation in order to match the recent finger position. When a key turns on, information regarding the “ON” pad sensors may be temporarily stored for certain preset times. The processor 220 may monitor the position by calculation of coverage of “ON” pad sensors and weight direction in a virtual key area. If the calculation result reaches a certain preset condition, the keypad position or size may be modified by the virtual key creation program described.

While the invention has been described with reference to the embodiments above, a person of ordinary skill in the art would understand that various changes or modifications may be made thereto without departing from the scope of the claims.

1. A method of creating a virtual keyboard on a portable electronic device comprising:
providing a multi-touch sensor area;
sensing a finger touch on the sensor area; and
creating virtual keypads having positions, wherein the keypads' positions are based on a user's finger touch, wherein the virtual keypads are created on the multi-touch sensor area.

2. The method of claim 1, wherein the positions of the virtual keypads are set based on predetermined parameters.

3. The method of claim 2, wherein the predetermined parameters are based on usage that the portable electronic device detects.

4. The method of claim 2, wherein the parameters are set by a user.

5. The method of claim 4, wherein at least one of the parameters is number of virtual keypads.

6. The method of claim 4, wherein at least one of the parameters is keypad size.

7. The method of claim 1, further comprising measuring a finger span area by detecting a range of finger movement and arranging the virtual keypads within the span area on the multi-touch sensor area.

8. The method of claim 1, wherein the creation of virtual keypads is based on stored information of a user's previous finger positions.

9. The method of claim 1, wherein the portable electronic device is cylindrical and comprises a holder that extends from the device.

10. The method of claim 1, further comprising:
providing at least one subsidiary virtual keypad separate from but adjacent to the virtual keypads.

11. The method of claim 10, wherein the virtual keypads and at least one subsidiary virtual keypad comprise directional indicators corresponding to directions for a mouse.

12. The method of claim 1, further comprising:
measuring a size of a virtual keypad by detecting a range of finger movement on the multi-touch sensor area.

13. A touch screen sensor equipped portable electronic device comprising:
a touch screen;
a contact analysis application that interacts with a position-detective touch sensor to detect a user's finger position on the touch screen;
a processor; and
a user setting application that allows a user to store virtual keypad settings;
wherein the processor creates a virtual keypad having a position on the touch screen, wherein the keypad's position on the touch screen is based on data received from the contact analysis application and the user setting application.

14. The touch screen sensor of claim 13 wherein the position of the virtual keypad is set based on a predetermined parameters.

15. The touch screen sensor of claim 14, wherein the predetermined parameters are based on usage that the portable electronic device detects.

16. The touch screen sensor of claim 14, wherein the parameters can be set by a user.

17. The touch screen sensor of claim 14, wherein at least one of the parameters is a number of virtual keypads.

18. The touch screen sensor of claim 14, wherein at least one of the parameters is keypad size.

19. The touch screen of claim 13, further comprising at least one subsidiary virtual keypad separate from but adjacent to the virtual keypad.

20. The touch screen of claim 19, wherein the virtual keypad and at least one subsidiary virtual keypad comprise directional indicators corresponding to directions for a mouse.
